(19) United States
(12) Patent Application Publication
(10) Pub. No.: US 2005/0071434 A1
(43) Pub. Date: Mar. 31, 2005

(54) System and method for sending a message to one or more destinations

(75) Inventors: Mark Bernard Hettish, Cary, NC (US); Jagjiwan S. Virk, Milpitas, CA (US)

Correspondence Address: Siemens Corporation;Attn: Elsa Keller, Legal Administrator, Intellectual Property Department, 170 Wood Avenue South, Iselin, NJ, 08830, US

(73) Assignee: Siemens Information and Communication Networks, Inc.

(21) Appl. No.: 10/673,941

(22) Filed: Sep. 29, 2003

(51) Int. Cl. G06F 15/16

(52) U.S. Cl. 709/207

(57) ABSTRACT

Embodiments provide a system, methods, apparatus, means, and computer program code for sending a message to one or more destinations.

### FIELD

The invention relates to a method, system, means and computer code for sending a message to one or more destinations.

### BACKGROUND

Applications may need to send notifications or other messages to various destinations. Such messages may be or include email messages, pager messages, instant messages, Web pages, etc. The destinations may be or include one or more user devices (e.g., pagers, personal digital assistants, cellular telephones, computers) associated with one or more users. As such, there is a need for a system, method, apparatus, means, and computer program code for enabling an application to send a message to different types of user destinations.

### SUMMARY

Embodiments provide a system, method, apparatus, means, and computer program code for sending a message to one or more destinations. In some embodiments, an application may be able to send a message to one or more different types of user destinations via an intermediary server or other device. The device may provide or act as an interface or intermediary that enables or allows the application to send a message to one or more destination addresses.

For example, an application may send data indicative of a message, an outgoing message type and a destination address to a device. The device then may use or convert the message into a format compatible with the outgoing message type and send the outgoing message to the destination address. One or more protocols (also referred to herein as notification interfaces) may be used or otherwise established so that the type and format of data provided by the application (and other applications) to the device is consistent. In addition, one or more protocols may be used or established so that the device can respond back to the application in a consistent format regarding the success or failure of delivery of the outgoing message to the destination address.

According to some embodiments, a method may include receiving data from an application, the data being indicative of a message, a destination address, and an outgoing message type; converting the message to an outgoing message in a format compatible with the outgoing message type; and sending the outgoing message to the destination address. In some other embodiments, a method may include establishing a protocol to receive data indicative of a message to be sent to a destination address, wherein the protocol includes parameters for destination address and outgoing message type; receiving data from an application, the data being compliant with the protocol and indicative of a first message, a first destination address, and a first outgoing message type; converting the first message to an outgoing message in a format compatible with the first outgoing message type; and sending the outgoing message to the first destination address. Other embodiments may include means, systems, computer code, etc. for implementing some or all of the elements of the methods described herein.

With these and other advantages and features of the invention that will become hereinafter apparent, the nature of the invention may be more clearly understood by reference to the following detailed description of the invention, the appended claims and to the drawings attached herein.

### BRIEF DESCRIPTION OF THE FIGURES

The accompanying drawings, which are incorporated in and form a part of the specification, illustrate embodiments of the invention.

FIG. 1 is a block diagram of a system according to some embodiments;

FIG. 2 is a flowchart of a method in accordance with some embodiments;

FIG. 3 is another flowchart of a method in accordance with some embodiments; and

FIG. 4 is a block diagram of representative components for the server of FIG. 1 that may be used in some embodiments.

### DESCRIPTION

Applicants have recognized that there is a market opportunity for systems, means, computer code, and methods that allow and enable an application to send data indicative of a message, an outgoing message type and a destination address to a device and have the device use or convert the message into a format compatible with the outgoing message type and send the outgoing message to the destination address. One or more protocols (also referred to as notification interfaces) may be used or otherwise established so that the type and format of data provided by the application is consistent. The protocol also may allow other applications to provide data in a manner consistent with the first application. In addition, one or more protocols may be used or established so that the device can respond back to the application in a consistent format regarding the success or failure of delivery of the outgoing message to the destination address, success or failure of the conversion, etc.

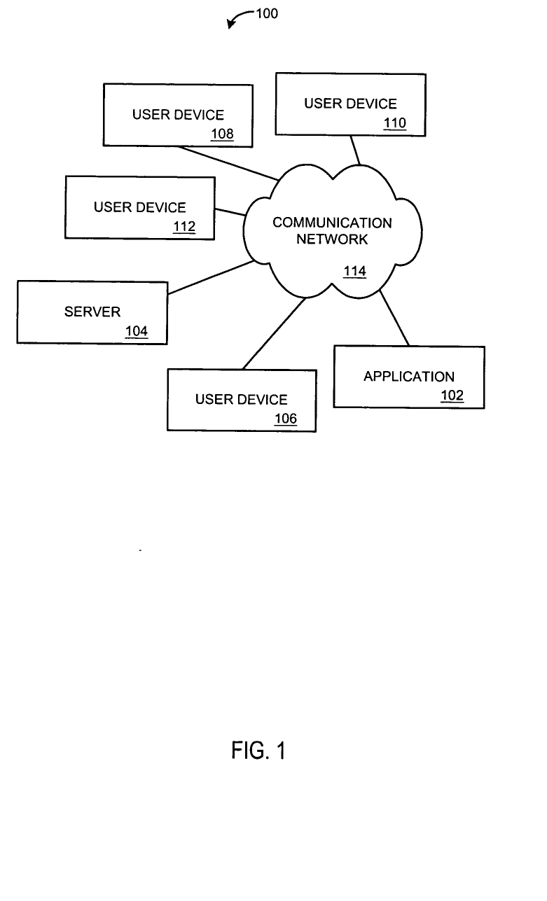

Now referring to FIG. 1, an exemplary system 100 is illustrated according to some embodiments. The system 100 includes an application 102 that may be in communication with a server 104 such that the application 102 can send data to the server 104 indicative of a message that the application 102 wants to be sent to the one or more destination addresses. In some embodiments, more than one application may send such data to the server 104.

In some embodiments, the server 104 may be or include a single device or computer, a networked set or group of devices or computers, a workstation, mainframe or host computer, etc. In some embodiments, the application 102 may be operating, resident, and/or installed on the server 104. In other embodiments, the application 102 may be operating, resident, and/or installed on a user or other device (e.g., cellular telephone, computer, personal digital assistant, two way pager, etc.) and one or more additional applications may be included in the system 100. The terms “user device”, “server” and “application” are used herein for convenience of explanation and no specific limitations are intended or implied by use of the terms “user device”, “server” or “application”.

Different destination addresses may be associated with different recipients, different devices, etc. For example, the application 102 may want to send a message to three people, each of which is associated with a different device (e.g., one of user devices 106, 108, 110, 112), destination address and/or communication channel. The first person may be available via email or otherwise be able to receive email messages. The second person may be available via pager or otherwise be able to receive pager messages. The third person may be available via instant messaging or otherwise be able to receive an instant message communication.

The application 102 provides the data to the server 104 indicative of the message, destination addresses (e.g., email address, pager address, instant message address) and the outgoing message type (e.g., email message, pager message, instant message). The server 104 then can convert the initial message into outgoing messages suitable for delivery to the destination addresses over the appropriate communication channel(s) or network. For example, the user device 106 may be a computer associated with the first person. The server 104 can send an email message that includes or is otherwise indicative of the message sent by the application 102 to the server 104 to the email address provided by the application 102 as a destination address. Thus, the email message may be delivered to the user device 106. Similarly, the user device 108 may be a pager device associated with the second person. The server 104 can send a pager message that includes or is indicative of the message sent by the application 102 to the pager address provided by the application 102 as a destination address. The pager message may be delivered to the user device 108.

In some embodiments, one or more of the components of the system 100 may be connected or in communication directly or indirectly with each other via a communication network, such as the communication network 114. In some embodiments, the network 114 may be, include, or be connected to the Internet, the World Wide Web, a local area network, a cellular or other telephone network, a wireless network or some other public or private computer, cable, telephone, client/server, peer-to-peer, or communications network or intranet. In some embodiments, the communications network 114 may include other public and/or private wide area networks, local area networks, wireless networks, data communication networks or connections, intranets, gateways, repeaters, hubs, database servers, Web site servers, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 114 may be implemented using a TCP/IP network and may implement voice or multimedia over IP using, for example, the Session Initiation Protocol (SIP).

Process Description

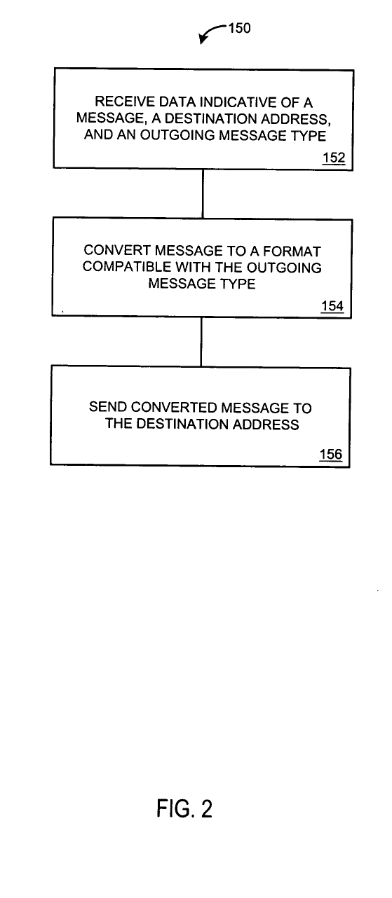

Reference is now made to FIG. 2, where a flow chart 150 is shown which represents the operation of a first embodiment. The particular arrangement of elements in the flow chart 150 is not meant to imply a fixed order to the elements; embodiments can be practiced in any order that is practicable. In some embodiments, the server 104 may implement one or more elements of the method 150.

During 152, the server 104 may receive data indicative of a message, a destination address, and an outgoing message type. For example, the application 102 may send the server 104 the data, so that the server 104 can convert the message into a format compatible or otherwise usable with the outgoing message type (e.g., email, text, instant message, pager message, facsimile transmission, short message service communication). The destination address may be compatible with the outgoing message type. For example, if the outgoing message type is “email message”, the destination address will be an email address. If the outgoing message type is “pager message”, the destination address may be or include a telephone number or other contact information needed to send the pager message.

In some embodiments, the data received during 152 may be included in or part of an XML (Extensible Mark-up Language) transmission, HTML (HyperText Mark-up Language), email message, text message, instant message, radio transmission, attachment, file transfer, database record transmission or retrieval, or other data or electronic communication.

The data received during 152 may comprise, be part of, or be indicative of a request for the server 104 to provide an appropriate outgoing message to the destination address using the message data received during 152. The server 104 then can provide a response to the sender of the data indicative of the success or failure of the request. That is, the server 104 may provide data to the sender indicative of the delivery or non-delivery of the outgoing message to the destination address.

In some embodiments, the data received during 152 may include other information. For example, in some embodiments the data may include one or more of the following: data indicative of the type of message sent by the application 102 to the server 104 (e.g., email, text, instant message, etc.), data indicative of the address (e.g., email address, instant message address) of the sender (e.g., the application 102), data indicative of the subject of the message, data indicative of the body of the message, data indicative of the type of conversion that should be used to create an outgoing message, data indicative of a specific conversion procedure, technique, or algorithm that should or can be used to create an outgoing message, data indicative of a maximum size limitation that should be used or observed when converting the message into the outgoing message and/or sending the outgoing message to the destination address (which may result in truncation of the original message or loss of part of the original message), data indicative of a server provider that should be used to send or deliver the message to the destination address, data indicative of the time and date the application send the other data, data indicative of a previous message that can be used or included, data indicative of if and/or how the server 104 should respond to receiving the data, data indicative of if and/or how the server 104 should indicate reception of the data, data indicative of if and/or how the server 104 should indicate delivery and/or a failure of delivery of the message to the destination address, data indicative of if and/or how the server 104 should indicate ability or inability to convert the message into a format compatible with the outgoing message type, data indicative of when the server 104 should send the outgoing message, data indicative of if, when or how the server 104 should indicate an ability or inability to use a designated service provider, data indicative if, how or when the server 104 should indicate an ability or inability to observe a maximum size limitation request or restriction, etc.

In some embodiments, the data received during 152 may be in accordance with an established or designated protocol or notification interface. Thus, in some embodiments, the method 150 may include determining or otherwise establishing the designated protocol or notification interface.

In some embodiments, the protocol may include one or more parameters that govern the format and content of data received by the server 104 during 152. For example, the protocol may require that certain types of data be provided in certain formats. For example, the message may need to be a text message. As another example, the data may need to include some or all of the information described above. As a further example, the data for different pieces of information (e.g., destination address, outgoing message type) may need to be provided in a specific order or used a designated convention.

During 154, the server 104 uses or otherwise uses or otherwise converts the message indicated in the data received during 152 to create an outgoing message compatible with the outgoing message type indicated in the data received during 152. For example, an incoming text message (for which the data was received during 152) may be converted into a message suitable for delivery via an instant message, short message service, email message, facsimile transmission, pager message, etc. In some embodiments, the data received during 152 also may specify or designate a conversion technique, format, algorithm, procedure to use in converting the message into the outgoing message. In other embodiments, a default conversion technique, format, algorithm, procedure may be used to convert the message into the outgoing message. In some embodiments, the server 104 may convert the message in the data received during 154 to an outgoing message that does not exceed a maximum size also specified or indicated in the data received during 154.

During 156, the server 104 sends the outgoing message to the destination address. Thus, the server 104 may take the message data received during 152 and converted into an outgoing message during 154 and send it to the destination address in the format designated by the outgoing message type indicated in the data received during 152. For example, during 156, the server 104 may send an instant message, email message, facsimile transmission, pager message, etc. in accordance with the destination address and the outgoing message type indicated in the data the server 104 received during 152. In some embodiments, the server 104 may send the outgoing message using or via a service provider indicated in the data received during 152. As another example, the server 104 may send the outgoing message such that the outgoing message does not exceed a maximum size limitation specified in the data received during 152.

In some embodiments, the method 150 may include the server 150 determining if the outgoing message can be sent to the destination address, determining if the outgoing message was received at the destination address, determining if the outgoing message type and the destination address are compatible, determining why an outgoing message failed to or otherwise did not reach the destination address, determining an error code or value (which may indicate a specific type of error or a specific type of error within an error category) and/or category (e.g., incompatibility error, operational error, transmission error, invalid destination address, invalid destination device, conversion error) if an outgoing message failed to reach destination address, sending a message to the sender of the data received during 152 confirming receipt of some or all of the data, sending a message to the sender of the data received during 152 confirming conversion of the message or an inability to convert the message into a format compatible with the outgoing message type, sending a message to the sender of the data received during 152 confirming conversion of the message or a an inability to convert the message into a format compatible with the outgoing message type, sending a message to the sender of the data received during 152 regarding ability or inability to use a designated service provider, sending a message to the sender of the data received during 152 regarding ability or inability to observe a maximum size request or limitation for an outgoing message, sending a message to the send of the data received during 152 confirming delivery of the outgoing message to the destination address, sending a message to the sender of the data received during 152 indicative of a failure or error in delivery of the outgoing message to the destination address, sending a message to the sender of the data received during 152 indicative of why an error (e.g., an error code or category) occurred in sending the outgoing message to the destination address, etc. Any data or message that may be sent to the sender of the data received during 152 may be sent to another designated device, application, address, etc. in addition or in lieu of the sending the message to the sender of the data received during 152.

In some embodiments, 152 may include receiving data at different times. For example, one or more of the data indicative of a message, data indicative of a destination address, and data indicative of an outgoing message type may be received by the server 104 at different times. Thus, for example, receiving data indicative of a message, a destination address, and an outgoing message type may include receiving first data indicative of the message; receiving second data indicative of the destination address; receiving third data indicative of the outgoing message type; receiving fourth data indicative of an instruction to use the first data to create the outgoing message. Thus, some of the data received during 152 may instruct the server to use a previously received message to create the outgoing message.

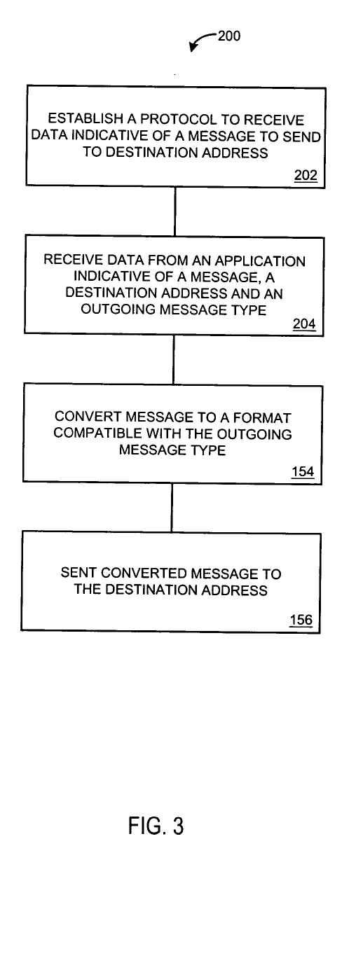

Reference is now made to FIG. 3, where a flow chart 200 is shown which represents the operation of a second embodiment. The particular arrangement of elements in the flow chart 200 is not meant to imply a fixed order to the elements; embodiments can be practiced in any order that is practicable. In some embodiments, the server 104 may implement one or more elements of the method 200. In some embodiments, the method 200 may include some or all of the variations discussed herein in regards to the method 150, and vice versa.

The method 200 includes the elements 154 and 156 previously discussed above. In addition, the method 200 includes 202, during which a protocol is determined or otherwise established. As previously discussed above, in some embodiments, the protocol may include on or more parameters regarding what information needs to be received by the server 104, how or in what format the information should be provided, etc.

In some embodiments, the method 200 may include establishing a protocol for the server responding to a sender of data and such protocol may include one or more parameters for responding to the sender. For example, the server 104 may respond to an application to indicate if an outgoing message has been delivered, or has failed to be delivered, to a destination address. As another example, the server 104 may respond to an application to indicate a reason or cause of error in a failure of a request for delivery of a message to be executed. Thus, the server 104 may provide information regarding a general error category or a specific error reason, code or value indicative of why an outgoing message was or could not be delivered to a destination address.

During 204, the server 104 receives data from an application indicative of a message, a destination address, and an outgoing message type in a manner similar to 152 previously discussed above. The data may be in or in accordance with the protocol established during 202.

As one example of a protocol that may be used in either the method 150 or the method 200, a protocol may be formatted or defined in XML or SOAP (Simple Object Access Protocol) and may be translated and supported as a WSDL (Web Services Description Language) interface using HTTP (HyperText Transport Protocol) as the transport. For example, one example notification interface formatted in XML is as follows:

```
<?xml version =“1.0” encoding =“UTF-8”?>
<xsd:schema targetNamespace=“http://siemens.com/magic/uns”
xmlns:xsd=“http://www.w3.org/2001/XMLSchema”
xmlns:csta=“http://www.ecma.ch/standards/ecma-323/csta”
xmlns:uns=“http://siemens.com/magic/uns” elementFormDefault=“qualified”
attributeFormDefault=“unqualified”>
    <xsd:element name=“SendNotificationMessage”>
        <xsd:annotation>
            <xsd:documentation> send-notification-
message</xsd:documentation>
        <xsd:annotation>
        <xsd:complexType>
            <xsd:sequence>
                <xsd:element name=“incomingMessageType”>
                    <xsd:simpleType>
                        <xsd:restriction base=“xsd:string”>
                            <xsd:enumeration value=“text”/>
                        </xsd:restriction>
                    <xsd:simpleType>
                </xsd:element>
                <xsd:element name=“outgoingMessageType”>
                    <xsd:simpleType>
                        <xsd:restriction base=“xsd:string”>
                            <xsd:enumeration value=“email”/>
                            <xsd:enumeration value=“pager”/>
                            <xsd:enumeration value=“shortMessageService”/>
                            <xsd:enumeration value=“instantMessage”/>
                        </xsd:restriction>
                    </xsd:simpleType>
                </xsd:element>
                <xsd:element Name=“senderAddress”>
                    <xsd:simpleType>
                        <xsd:restriction base=“xsd:string”/>
                    </xsd:simpleType>
                </xsd:element>
                <xsd:element name=“destinationAddress” type=“xsd:string”
maxOccurs=“20”/>
                <xsd:element name=“subject” type=“xsd:string” minOccurs=“0”/>
                <xsd:element name=“body” type=“xsd:string”/>
                <xsd:element name=“serviceProvider” type=“xsd:string”
minOccurs=“0”/>
                <xsd:element name=“maxSize” type=“xsd:unsignedInt”
minOccurs=“0”/>
            </xsd:sequence>
        </xsd:complexType>
        <xsd:element name=“SendNotificationMessageResponse”>
            <xsd:complexType>
                <xsd:sequence>
                    <xsd:element name=“messageResponse”
type=“xsd:boolean”/>
                    <xsd:element name=“errorCategory” minOccurs=“0”>
                        </xsd:annotation>
                        <xsd:simpleType>
                            <xsd:restriction base=“xsd:string”>
                                <xsd:enumeration value=“OperationErrors”/>
                                <xsd:enumeration
value=“StateIncompatibilityErrors”/>
                                <xsd:enumeration value=“UniversalFailure”/>
                            </xsd:restriction>
                        </xsd:simpleType>
                    </xsd:element>
                    <xsd:element name=“errorValue” minOccurs=“0”>
                        </xsd:annotation>
                        <xsd:simpleType>
                            <xsd:restriction base=“xsd:string”>
                                <xsd:enumeration value=“generic”/>
                                <xsd:enumeration value=“invalidObjectType”/>
                                <xsd:enumeration
value=“invalidDestinationDeviceID/”>
                                <xsd:enumeration
value=“invalidCallingDeviceState”/>
                                <xsd:enumeration value=“operation”/>
                            </xsd:restriction>
                        </xsd:simpleType>
                    </xsd:element>
                </xsd:sequence>
            </xsd:complexType>
        </xsd:element>
    </xsd:schema>
    </xsd:schema>
```

In the example above, the request is named “SendNotificationMessage” and the response is named “SendNotificationMessageResponse”. As illustrated in the example, the protocol or notification interface example provided above follows a request-response model includes the following functions:
Request name:
   SendNotificationMessage.
Parameters:
   IncomingMessageType
      Text—message is a text message.
   OutgoingMessgeType
      Email—user or outgoing message destination type is email.
      Pager—user or outgoing message destination type is pager.
      ShortMessageService—user or outgoing message destination type is a short message service communication.
      InstantMessage—user or outgoing message destination type is an instant message communication.
   SenderAddress
      Address of sender of the user notification (e.g., email address).
   DestinationAddress
      Address of destination.
   Subject
      Subject of message.
   Body
      Body of message.
   ServiceProvider
      Service provider to use to deliver the outgoing message.
   MaxSize
      The maximum size of the outgoing message to send to the destination address.
Description
   This request allows an application to ask the server 104 to take an existing message (e.g., a text message already provided to the server 104) and convert it into the outgoing message for delivery to the destination address.
Response name
   SendNotificationMessageResponse.
Parameters
   UserNotificationMessageResponse
      MessageResponse
         Indicates success or failure of request.
      ErrorCategory
         If the request failed, indicates the general category of the error.
      ErrorValue
         If the request failed, indicates the specific value of the error.
Description
   Indicates the success or failure of the request.

In some embodiments, the protocol or notification interface can be expanded to include or support other request-response pairs or functions needed or used to support all types of outgoing message types, incoming messages, applications, destination addresses, conversion functionalities or techniques, or user devices.

Server

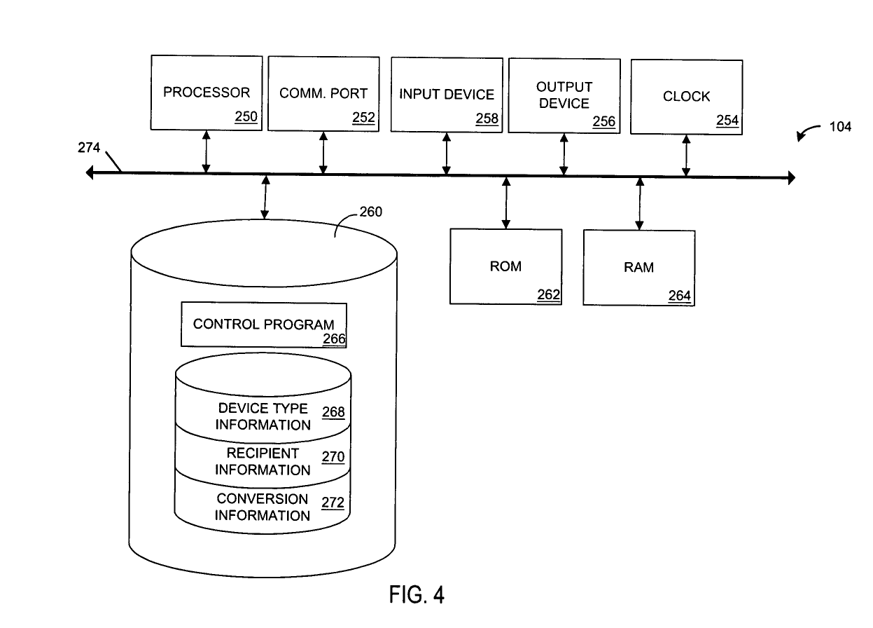

Now referring to FIG. 4, a representative block diagram of the server or controller 104 is illustrated. The server 104 can comprise a single device or computer, a networked set or group of devices or computers, a workstation, mainframe or host computer, etc. In some embodiments, the server 104 may implement or be adapted to implement one more elements of the methods disclosed herein.

The server 104 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 104 also may include an internal clock element 254 to maintain an accurate time and date for the server 104, create time stamps for messages, data or other communications received or sent by the server 104, etc.

If desired, the server 104 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 104 may include a memory or data storage device 260 to store information, software, databases, documents, communications, device drivers, etc. The memory or data storage device 260 may include an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 104 also may include separate ROM 262 and RAM 264.

The processor 250 and the data storage device 260 in the server 104 each may be, for example: (i) located entirely within a single computer or other computing device; or (ii) connected to each other by a remote communication medium, such as a serial port cable, telephone line or radio frequency transceiver. In one embodiment, the server 104 may comprise one or more computers that are connected to a remote server computer for maintaining databases.

A conventional personal computer or workstation with sufficient memory and processing capability may be used as the server 104. The server 104 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 250. Equivalent or other processors may be available from Motorola, Inc., AMD, or Sun Microsystems, Inc. The processor 250 also may comprise one or more microprocessors, computers, computer systems, etc.

Software may be resident and operating or operational on the server 104. The software may be stored on the data storage device 260 and may include a control program 266 for operating the server, databases, etc. The control program 266 may control the processor 250. The processor 250 preferably performs instructions of the control program 266 and may implement one or more elements of the methods disclosed herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 104 also may include or store information regarding identities, user devices, contexts, mapping tables, communications, etc. For example, information regarding one or more devices (e.g., type, configuration, capabilities) may be stored in a device information database 268 for use by the server 104 or another device or entity. Information regarding one or more recipients (e.g., names, email addresses, associated device identifiers) may be stored in a recipient information database 270 for use by the server 104 or another device or entity and information regarding conversion rules, processes, etc. may be stored in a conversion information database 272 for use by the server 104 or another device or entity. In some embodiments, some or all of one or more of the databases may be stored or mirrored remotely from the server 104.

In some embodiments, the instructions of the control program may be read into a main memory from another computer-readable medium, such as from the ROM 262 to the RAM 264. Execution of sequences of the instructions in the control program causes the processor 250 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 250, communication port 252, clock 254, output device 256, input device 258, data storage device 230, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware/software configurations for the server 104 have been illustrated, it should be noted that other implementations and hardware configurations are possible and that no specific implementation or hardware/software configuration is needed. Thus, in some embodiments, not all of the components illustrated in FIG. 4 may be needed for the server 104 implementing one or more of the elements of the methods disclosed herein. For example, in some embodiments, a system may include a processor; a communication port coupled to the processor and adapted to communicate with one or more network devices; and a storage device coupled to the processor and storing instructions adapted to be executed by the processor to receive data, the data being indicative of a message, a destination address, and an outgoing message type; use or otherwise convert the message indicated in the data to an outgoing message in a format compatible with the outgoing message type; and send the outgoing message to the destination address. In some embodiments, the data may be indicative of other parameters (e.g., maximum outgoing message size, designated service provider, sender address, sender name, incoming message type, etc.). As another example, a system may include a processor; a communication port coupled to the processor and adapted to communicate with one or more network devices; and a storage device coupled to the processor and storing instructions adapted to be executed by the processor to establishing a protocol to receive data indicative of a message to be sent to a destination address, wherein the protocol includes parameters for destination address and outgoing message type; receiving data from an application, the data being compliant with the protocol and indicative of a first message, a first destination address, and a first outgoing message type; converting the first message to an outgoing message in a format compatible with the first outgoing message type; and sending the outgoing message to the first destination address. In other embodiments, the protocol may include other parameters (e.g., maximum outgoing message size, designated service provider, sender name, sender address, etc.)

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although embodiments have been described with respect to various embodiments thereof, those skilled in the art will note that various substitutions may be made to those embodiments described herein without departing from the spirit and scope of the system, methods, code, etc. described herein. Any embodiments described in the above detailed description are non intended to be limited to the specific form set forth herein, but is intended to cover such alternatives, modifications and equivalents as can reasonably be included within the spirit and scope of the appended claims.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method, comprising:
receiving data from an application, said data being indicative of a message, a destination address, and an outgoing message type;
converting said message to an outgoing message in a format compatible with said outgoing message type; and
sending said outgoing message to said destination address.

2. The method of claim 1, further comprising:
establishing a protocol for receiving data indicative of a message to be sent to a destination address.

3. The method of claim 2, wherein said protocol includes parameters for outgoing message type and destination address.

4. The method of claim 2, wherein said protocol includes parameters for incoming message type and sender address.

5. The method of claim 2, wherein said protocol includes a parameter for a service provider to be used to send said outgoing message.

6. The method of claim 2, wherein said protocol includes a parameter for a maximum size of said outgoing message.

7. The method of claim 1, wherein said data is indicative of an address associated with a sender of said message.

8. The method of claim 1, wherein said data is indicative of a service provider to use in said sending said outgoing message to said destination address.

9. The method of claim 8, wherein said sending said outgoing message to said destination address includes sending said outgoing message to said destination address via said server provider.

10. The method of claim 1, wherein said data is indicative of a maximum size for said outgoing message.

11. The method of claim 10, wherein said converting said message to an outgoing message in a format compatible with said outgoing message type includes converting said message into said outgoing message such that said outgoing message does not exceed said maximum size.

12. The method of claim 1, further comprising:
sending a response message to said application, said response message being indicative of a delivery of said outgoing message to said destination address.

13. The method of claim 1, further comprising:
sending a response message to said application, said response message being indicative of an error in delivery of said outgoing message to said destination address.

14. The method of claim 1, wherein said receiving data from an application, said data being indicative of a message, a destination address, and an outgoing message type includes:
receiving first data indicative of said message;
receiving second data indicative of said destination address;
receiving third data indicative of said outgoing message type; and
receiving fourth data indicative of an instruction to use said first data to create said outgoing message.

15. The method of claim 1, further comprising:
determining that said outgoing message was not delivered to said destination address.

16. The method of claim 1, wherein said receiving data from an application, said data being indicative of a message, a destination address, and an outgoing message type includes receiving said data in accordance with a pre-established protocol.

17. The method of claim 1, further comprising:
establishing a protocol indicative of how to send a message to a sender of said data.

18. A method, comprising:
establishing a protocol to receive data indicative of a message to be sent to a destination address, wherein said protocol includes parameters for destination address and outgoing message type;
receiving data from an application, said data being compliant with said protocol and indicative of a first message, a first destination address, and a first outgoing message type;
converting said first message to an outgoing message in a format compatible with said first outgoing message type; and
sending said outgoing message to said first destination address.

19. The method of claim 17, wherein said protocol includes parameters for incoming message type and sender address.

20. The method of claim 17, wherein said protocol includes a parameter for a service provider to be used to send said outgoing message.

21. The method of claim 17, wherein said protocol includes a parameter for a maximum size of said outgoing message.

22. The method of claim 17, wherein said protocol includes at least one parameter for providing data to said application indicative of an error in delivery of said outgoing message to said destination address.

23. An article of manufacture comprising:
a computer readable medium having stored thereon instructions which, when executed by a processor, cause said processor to:
receive data from an application, said data being indicative of a message, a destination address, and an outgoing message type;
convert said message to an outgoing message in a format compatible with said outgoing message type; and
send said outgoing message to said destination address.

24. A system, comprising:
a processor;
a communication port coupled to said processor and adapted to communicate with at least one device; and
a storage device coupled to said processor and storing instructions adapted to be executed by said processor to:
receive data from an application, said data being indicative of a message, a destination address, and an outgoing message type;
convert said message to an outgoing message in a format compatible with said outgoing message type; and
send said outgoing message to said destination address.
